(19) United States
(12) Patent Application Publication
(10) Pub. No.: US 2015/0248414 A1
(43) Pub. Date: Sep. 3, 2015

(54) CONTACT DATA ENGINE

(71) Applicants: Lizzabeth Brown, Johnston, RI (US); Vincent Brown, Johnston, RI (US)

(72) Inventors: Lizzabeth Brown, Johnston, RI (US); Vincent Brown, Johnston, RI (US)

(21) Appl. No.: 14/712,984

(22) Filed: May 15, 2015

Related U.S. Application Data
(63) Continuation-in-part of application No. 14/206,216, filed on Mar. 12, 2014.
(60) Provisional application No. 61/993,388, filed on May 15, 2014.
(60) Provisional application No. 62/052,789, filed on Sep. 19, 2014.
(60) Provisional application No. 61/779,794, filed on Mar. 13, 2013.
(60) Provisional application No. 61/870,262, filed on Aug. 27, 2013.

(51) Int. Cl. G06F 17/30

(52) U.S. Cl. CPC G06F 17/3053; G06F 17/30864

(57) ABSTRACT

A method of tracking performance metrics of contact data in a networked computer environment, the contact data including organizations, events, event counters, and cards, generally includes assigning points from a point pool to a plurality of events according to user desired importance of each event over a specified time frame; optionally, calculating a weighted score goal (G) based on the assigned points of an event related to the point pool; assigning a desired weekly event target (T) to each event, representing the desired number of weekly event occurrences; tracking event occurrences (A) within the specified time frame; optionally, calculating a weighted percentage score (S) of a weekly event target (T) in relation to the total point pool; and reporting the result of the event occurrences (A) versus event targets over the specified time frame.

### CROSS-REFERENCE TO RELATED APPLICATION

This patent document claims priority to earlier filed U.S. Provisional Patent Application No. 61/993,388, filed on May 15, 2014, and U.S. Provisional Patent Application No. 62/052,789, Filed on Sep. 19, 2014, and is a continuation-in-part application of U.S. patent application Ser. No. 14/206,216, filed on Mar. 12, 2014, which claims priority to earlier filed U.S. Provisional Patent Application No. 61/779,794, filed Mar. 13, 2013, and U.S. Provisional Patent Application No. 61/870,262, filed Aug. 27, 2013, the entire contents of which are incorporated herein by reference.

### BACKGROUND OF THE INVENTION

1. Technical Field

The present patent document relates generally to contact data management and more particularly to a method and system to propagate and maintain relationship links for contact data throughout a network or businesses and people.

2. Background of the Related Art

Computer systems and databases optimized for contact management that operate in a private networked environment suffer from the disadvantage that the contact information is not easily shared. Furthermore, these prior art systems do not maintain the relationship link between the contacts, thus not fully utilizing the contact data.

As shown in FIG. 1, a prior art method of sharing contact data is shown, such as Microsoft Outlook and Exchange products and Lotus Notes. As people become established in a particular field they develop a network of people with whom they regularly do business. When/if they change their contact information due to change of job, residence or other reasons it is very difficult if not impossible to easily notify all those who might have their business card. Typically, their network information is tied to a proprietary system owned by the company for which they work and is not transferable to another system.

Social network-style solutions to contact management, such as LinkedIn and AngiesList.com, have the additional disadvantage of becoming cluttered with comments and ratings.

Accordingly, there is a perceived need in the prior art of a method and system to manage contact data that provides for more fluid sharing of contact data between businesses and individuals and maintains the relationship link between contacts.

### SUMMARY OF THE INVENTION

The present invention solves the problems of the prior art by providing a contact data management system and method that allows people who maintain a business card or business contact information to easily update, maintain and propagate that information when/if it changes. Also, the method and system described herein allows such people to easily propagate any changes to their network of trusted business relations. Because of the nature of the data storage, propagation of this information is made possible across multiple computer operating systems and software environments.

Further, the method and system includes a method of tracking performance metrics for events within the system in order to generate

### BRIEF DESCRIPTION OF THE DRAWINGS

These and other features, aspects, and advantages of the present invention will become better understood with reference to the following description, appended claims, and accompanying drawings where:

FIG. 1 is a prior art representation for a method of distributing contact information;

FIG. 2 is an illustration of contact data being propagated between users;

FIG. 3 is an illustration of an internal data structure of the contact data engine;

FIG. 4a is an illustration of a collection of card illustrating tagging the cards;

FIG. 4b is an illustration of a screen for searching for a contact via tags;

FIG. 4c is an illustration of an internal data structure of relationship between contact data and tags;

FIG. 5 is an illustration of showing editing the contact information of a card;

FIG. 6 is an illustration showing a user claiming ownership of a card;

FIG. 7 is an illustration showing a user adding a card to their collection;

FIG. 8 is an illustration showing a user's collection of cards;

FIG. 9 is an illustration of a user sharing a card with another user;

FIG. 10 is an illustration showing a step of a user selecting cards to be shared;

FIG. 11 is an illustration showing a step of a user entering a recipient's email address to facilitate sharing of cards;

FIG. 12 is an illustration of a recipient logging into the system and seeing a notification that cards have been shared to them;

FIG. 13 is an illustration of a recipient viewing a screen to select whether to accept or decline a shared card;

FIG. 14 is an illustration showing a user adding a relationship to cards in their collection;

FIG. 15 is an illustration showing a user searching for cards in their collection and other searchable cards;

FIG. 16 is an illustration showing a screen where a user can manually create a new card and enter contact information;

FIG. 17 is an illustration showing a screen where a user can create a group;

FIG. 18 is an illustration showing a screen where a user can enter a name for the group;

FIG. 19 is an illustration showing a screen where a user may add cards to a group;

FIG. 20 is an illustration showing a screen where a user may view only cards in a particular group;

FIG. 21 is an illustration showing a screen where a user may create a card for a person that does not have an account in the system;

FIG. 22 is an illustration showing a screen where a user my send an invitation to a person that does not have an account in the system;

FIG. 23 is an illustration showing a menu bar where a user may manage their group affiliations;

FIG. 24 is an illustration of a data structure illustrating group types;

FIG. 25 is an illustration of the relationships between cards, organization cards, organizations, groups, group cards and group types within the system;

FIG. 26 is an illustration of a screen where a use may assign points from a point pool to events the user desires to track performance metrics for;

FIG. 27 is an illustration of a screen illustrating a report of performance metrics to the user;

FIG. 28 is an illustration of data flow and tracking of event occurrences to the system and subsequent reporting; and

FIG. 29 is an illustration of the relationships between an event, event counter and a profile within the system.

### DESCRIPTION OF THE PREFERRED EMBODIMENT

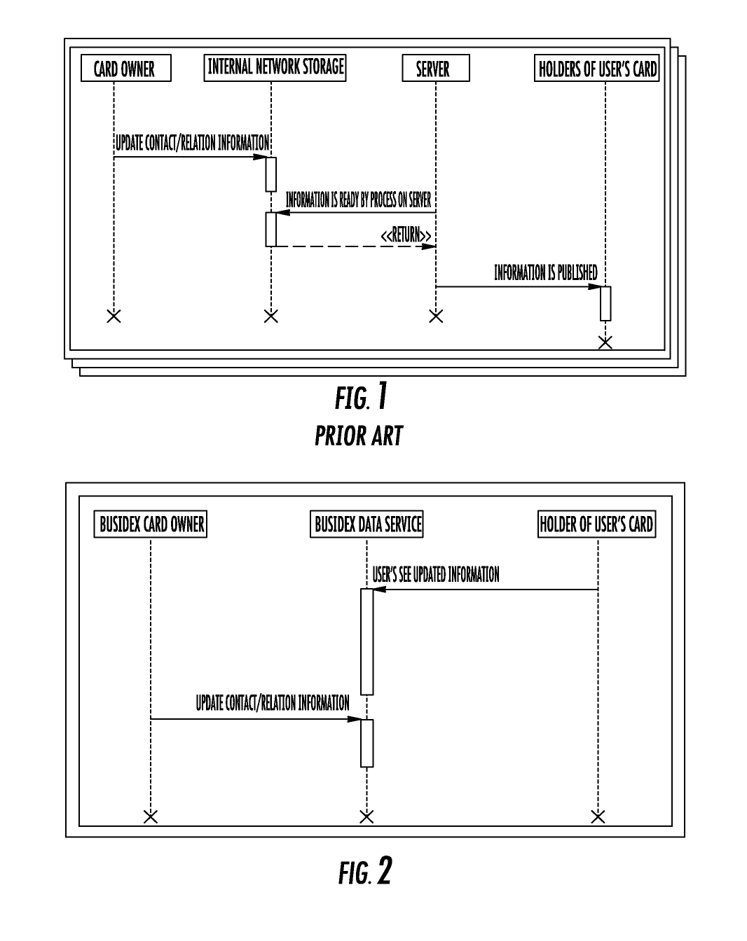

Referring now to FIG. 2, and as will be more fully described below, an illustration of the method and system of propagating contact data between users is shown. The method and system, also called Busidex, is a cross-platform business card/contact information engine which allows users to easily update, maintain and share their business card data. The data repository is available via the internet and mobile devices. The following diagrams and charts describe the internal structure and behaviors of the system. Contact data is propagated through a Busidex Data Service

It should be understood that the present invention may be employed in any type of operating system. The present invention may be implemented in any type of software code using any language and can run on any type of computer hardware or networked computer hardware, including virtual machines. The computer hardware, virtual or physical, generally includes a processor, a program memory, and a data storage. The computer hardware may be networked, wired and wirelessly, to other computer hardware and accessible via other electronic devices, such as smartphones, PDA's and the like.

Referring to FIG. 3, the contact data, or card, is the central data structure and has attributes that describe contact information. One and only one instance of a card exists in the system at any given time. References to cards are made discoverable to and shared with users through Busidex Data Services. Cards may be edited by the Card Owner or, if Card Owner does not exist, the User that uploaded the card into the Busidex Data Services. Cards have a number of different elements, including one or more addresses, phone numbers, and/or tags. The central data structure is preferably stored as in a relational database, where relations may be maintained between the cards and card owners and users of the system. No particular relational database system is required and the system may be implemented using any of a variety of open source or proprietary platforms known in the art, such as Oracle Database, IBM DB2, IBM Informix, MySQL, Microsoft SQL Server, PostgreSQL, Amazon AWS, and the like.

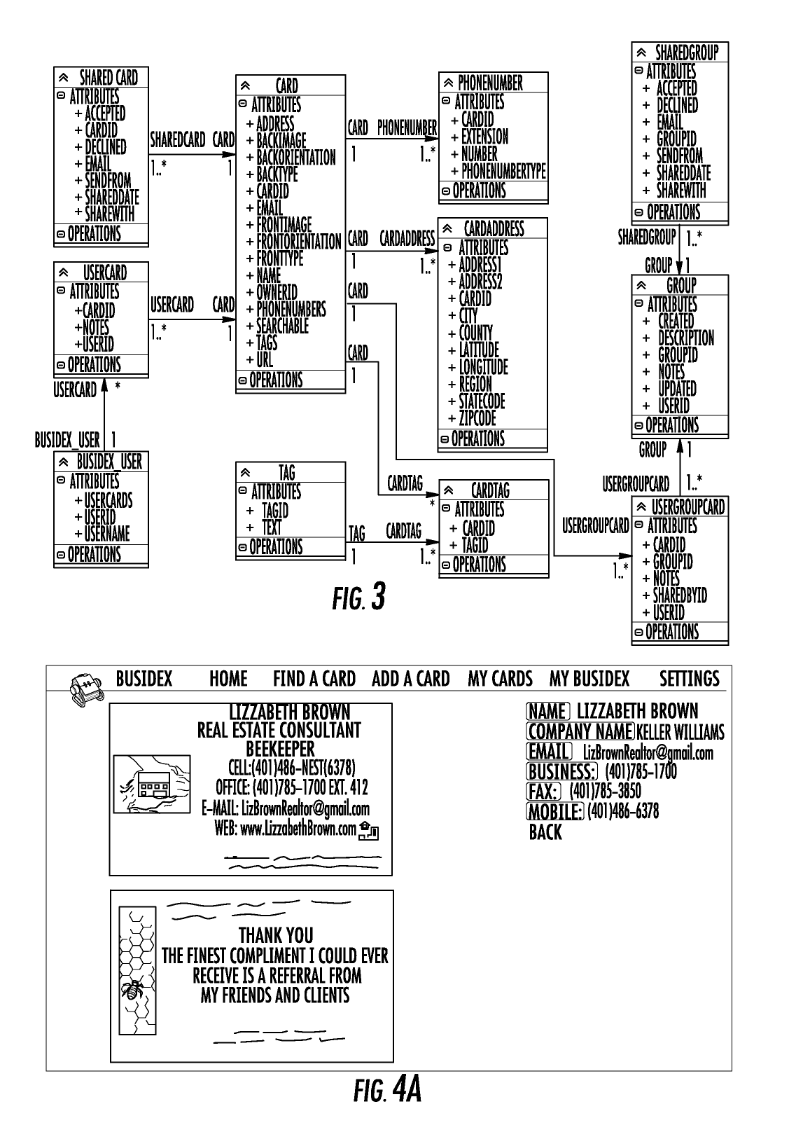

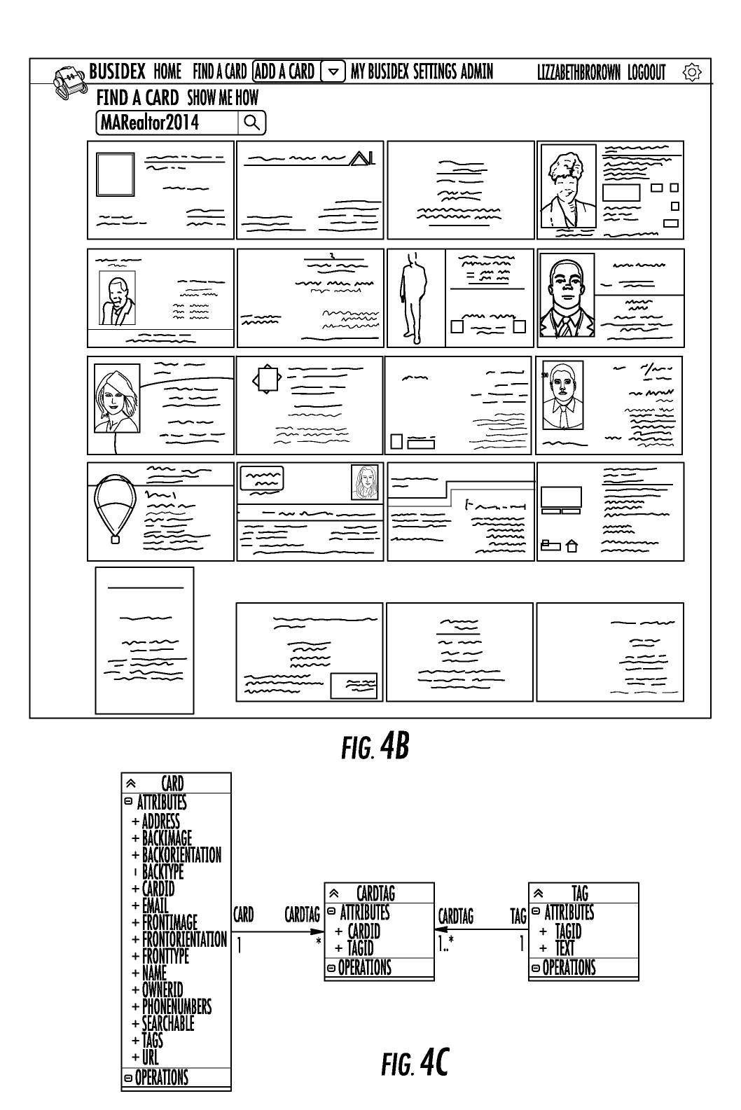

Referring to FIGS. 4a-c, each card may have one or more associated tags, used for searching, described further below, and organizing a user's cards. Tags are user-defined descriptive phrases that categorize cards. The same tag may be applied to one or more cards. Tags are one of the more powerful mechanisms in the Contact Data Engine, mainly because of the way they uniquely identify a Card in such a way as to be easily remembered. But they may also be used to identify a collection of Cards related by industry, proximity, personal relation or any other criteria.

One very specialized use of Tags is as a conference code. Business owners frequently attend trade shows, conferences and other such meetings with professionals in like industries. There is great value in maintaining these relationships after these events are over. Each Card Owner attending such an event would be given a unique Tag (some memorable word or phrase as it relates to the event) which can then be used as a quick lookup using the Contact Data Engine.

For example, as shown in FIG. 4b, forty-five members of the MA Realtors Association attend the annual Realtor's conference. Each member has their Card in the Busidex platform. As part of the conference, each member is given the Tag “MARealtors2014”. From that point on, any time a member wants to contact someone who attended that conference, they simply search for that Tag using the Contact Data Engine without having to remember names or hunt through scraps of paper looking for phone numbers.

Another unique usage for Tags within the Busidex platform is for creating a Membership Directory. The Membership Directory can have 1 . . . n levels of depth by combining Tags. For example, using the Tag “Dynex” someone can look up all employees of the Dynex company. Adding “Marketing” to the Tag search filters the list down to those employees working in the Marketing department. This filter can go as deep as is desired simply by adding Tag filters. This works by using a logical AND to combine Tag filters. In the Dynex example above, only cards with the Tags “Dynex” AND “Marketing” are shown.

Referring to FIG. 4c (also shown in FIG. 3), the data structure and relationship between the Tag and the Contact that makes this possible is a simple one-to-many relationship, where each tag is unique, thereby allowing for a Dictionary lookup at runtime.

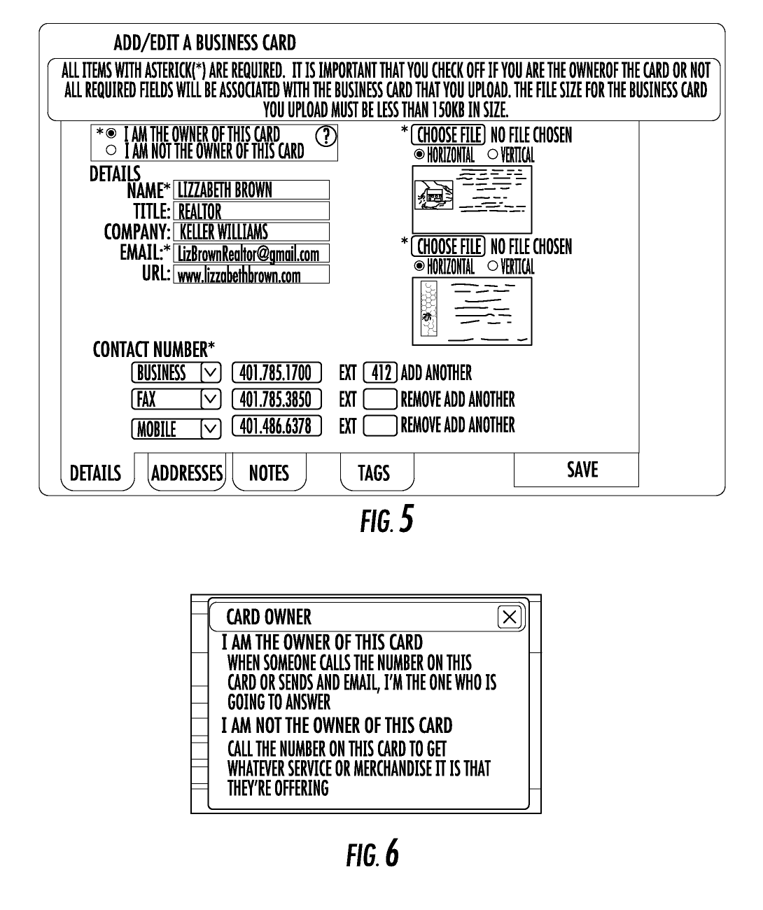

Referring to FIGS. 5 and 6, each card may be assigned a Card Owner. A Card Owner is defined as the person who is referenced by the contact information associated with the card i.e. Address, Phone Number, and/or Email. Once a card is owned, only the Card Owner may edit that particular card.

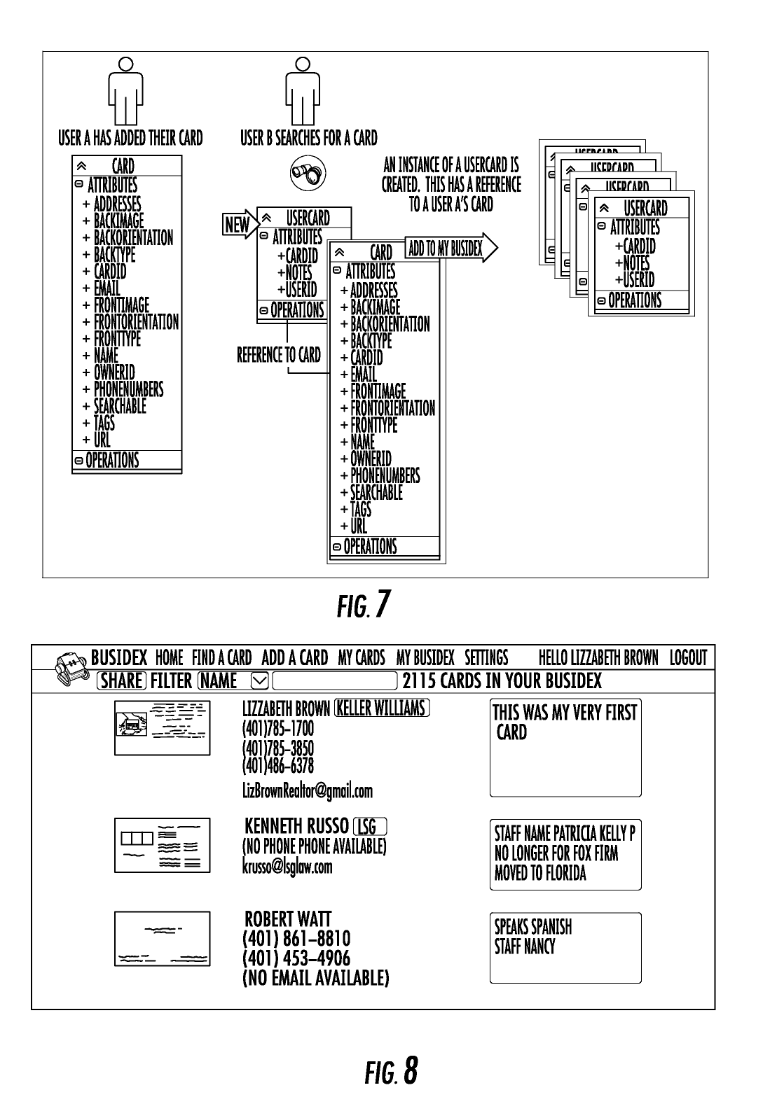

Referring to FIGS. 7 and 8, a user's cards are stored in a personal collection, called MyBusidex. Users can add cards to their personal collection, but may only edit Cards that they own or that they uploaded and are not owned. The collection contains references to cards, but not the actual card, which is unique to the system. When a card is updated, all references to that Card in any MyBusidex collections see the updates immediately. A user may add their own personal notes to a card, but these notes are not propagated through the system and remain private to the user that created the note.

Referring to FIG. 9, users may share cards to other users. When a card is shared, an instance of a shared card is created and transmitted to the recipient. The recipient may choose to accept or decline the card. If accepted, an instance of the card (with a reference to the original card) is created and stored in the recipient's MyBusidex collection.

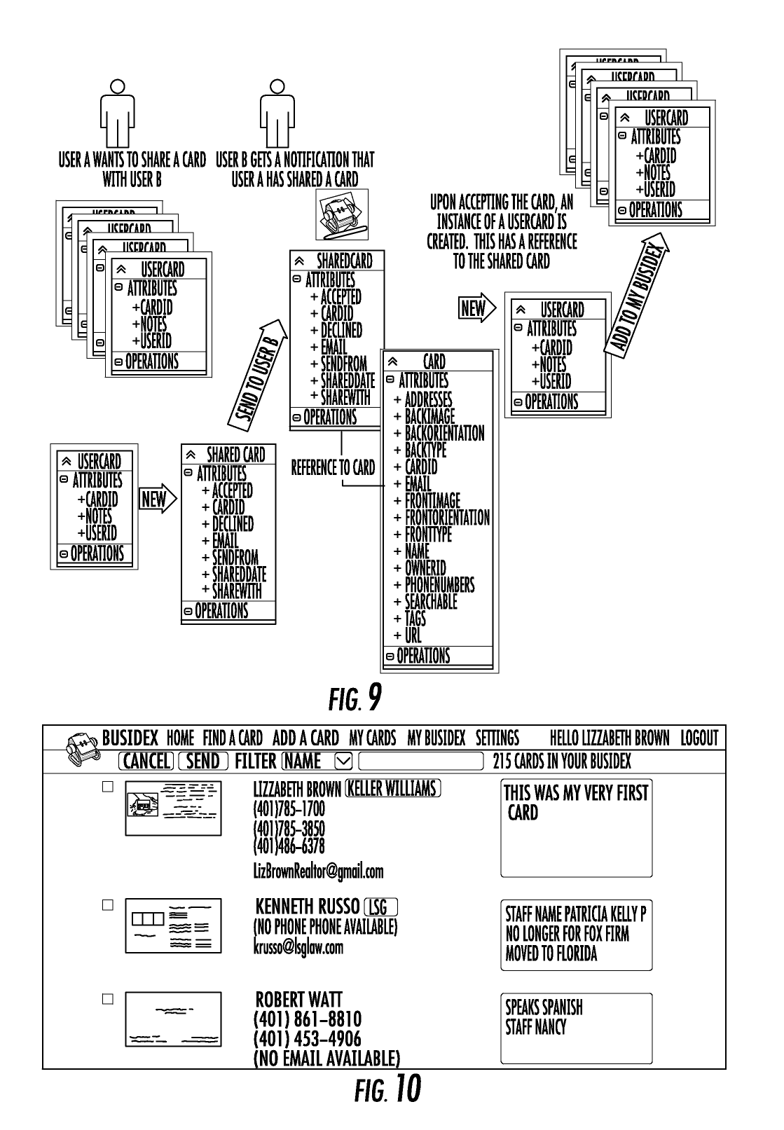

Referring to FIG. 10, the system and method provides a screen for a user to select one or more cards to share. The user, via a graphical interface, my select as many cards in their own collection to share as are available.

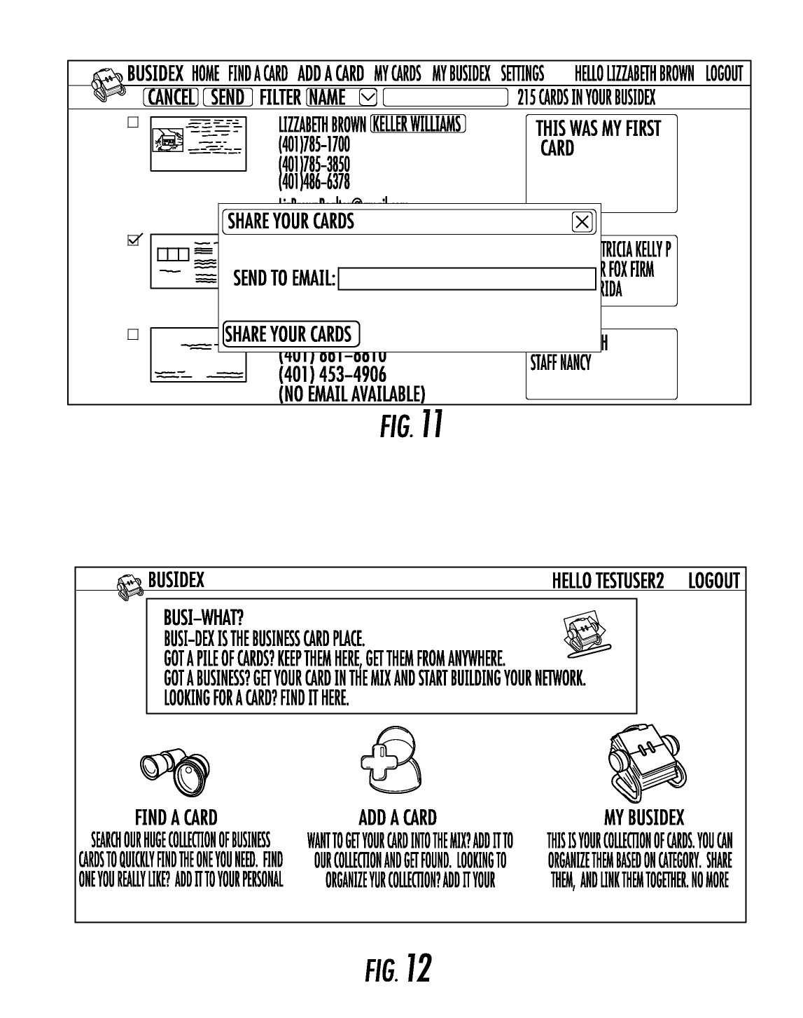

Referring to FIG. 11, the system and method provides for a user to enter an email address of a person with whom to the share the selected cards from the step shown in FIG. 10.

Referring to FIG. 12, the recipient logs into the system, where they receive a shared card notification. Cards are filtered from searches based on a Privacy flag, which allows a Card owner to control who can view and share their Card. There are three different Privacy Flags—Public, Semi-Public, and Private.

With the Privacy flag set to Public, anyone can find the user's card, and add it to their collection and share it. With this option a Card will be completely searchable by name, company, title, email, and any tag is have associated with the Card. Anyone with or without a Busidex Account can find the Card in a search, and only those that do have a Busidex Account can add the Card to their Busidex Account.

With the Privacy Flag set to Semi-Public, a user's card can be found only by those with whom it has been shared, and anyone can share your card. During searches, the user's card will not be searchable by anyone except by those that have a Busidex account with whom the card has been shared. If a Card is shared with someone that does not have a Busidex account they will need to open an account to view the Card in their Busidex page. Once a Card is shared, those with whom the Card has been shared have authorization to then share the Card with whomever they wish.

With the Privacy Flag set to Private, a Card can only be found by those with whom it has been shared, and only the Card owner can share the card. With this option a Card can only be shared by the Card owner. Even those that have your Card in their Busidex collection cannot share it. The Card owner is the only person that can Share the Card with others.

Referring to FIG. 13, the recipient may accept or decline the shared cards. If accepted, the card will be added to the recipient's cards, i.e. MyBusidex collection.

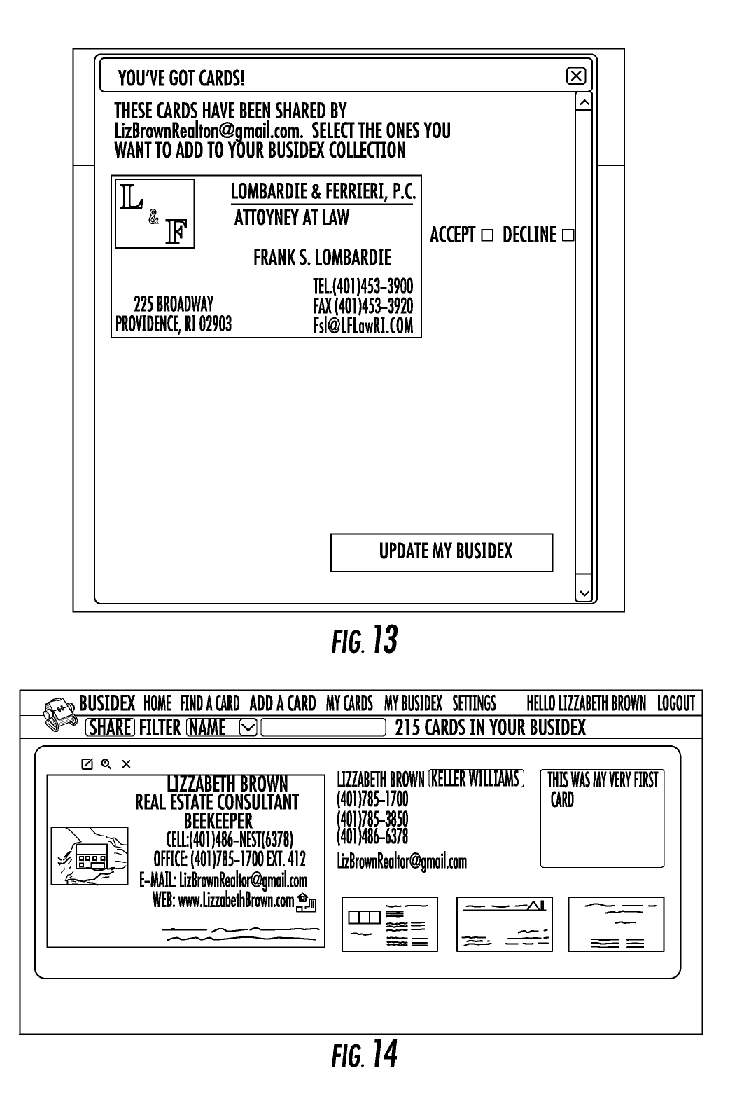

Referring to FIG. 14, the user may create, update and delete a relationship for each card in their collection. Card Owners may select cards in their MyBusidex collection to be ‘related’ or associated with their own card. Related cards, which are shared, will show up in the card details for all those with whom the cards are shared. For example, User A is a Real Estate Agent. User A may choose to upload two loan officer's cards and a lawyer's card to their MyBusidex collection. User A marks those cards as Related to his own card. User A has a client (User B), and shares the related cards with User B. When User B views User A's card in their MyBusidex collection, the related cards will appear along with User A's card. The related cards only show in User B's MyBusidex collection, because although they are marked as related, they were only shared with this User B. When other clients view User A's card in their Busidex collection, they do not see the related cards, since User A did not share those cards with them. The Busidex Data Service recognizes when to show the list of related cards to a user by locating a matching record in Card Relation table

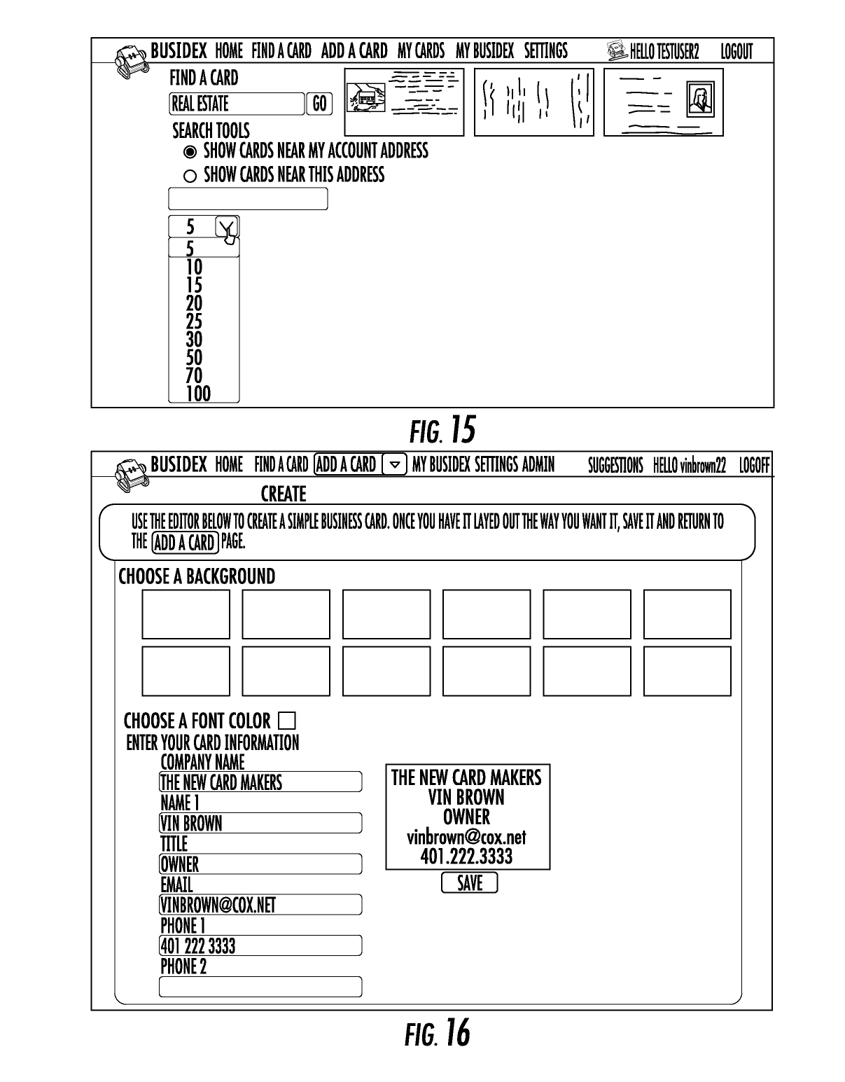

Referring to FIG. 15, a user may search through their MyBusidex collection and all cards that are searchable. Cards are considered “searchable” if they have a Card Owner; otherwise they are not publicly visible. If a user is logged in, the scope of a Search includes all cards in their MyBusidex collection as well as all Searchable Cards. Search criteria may include tags, names, phone numbers, and/or company or employer name. Because geo-location is also an attribute of a Card, it is possible to limit a search to a distance radius or defined geographic area, such as a state, city, or metropolitan area.

Referring to FIG. 16, the system and method provides for a user to manually create a card using an online editor. Using the online form, users can choose the card background color, font color and enter card attributes while getting immediate visual feedback as to what the card will look like. The system will save the HTML markup used to display the card and store it on the card record. Cards may also be imported using scanners or common file formats, such as CSV and other delimited formats. A user may also import third party contacts into their Busidex from other sources, such as email service contact lists, like gMail, Yahoo mail, outlook contacts and the like, and may further send invitations to selected contacts from those lists.

Referring to FIGS. 17-22, users can organize their cards into groups, or Busigroups. One card can be in zero or many Busigroups. A Busigroup can contain as many cards as the user wants. Busigroups may also be shared between users. The users in a group of shared cards may add notes to each card in the Busigroup. Each user's notes are only visible to the owner of the Busigroup, and not the other users. All members of the group receive notifications when new cards have been added to the group. Only the owner of the group may add and remove cards. The Busigroup owner may add notes to all the cards in the Busigroup, which are visible to all the group members.

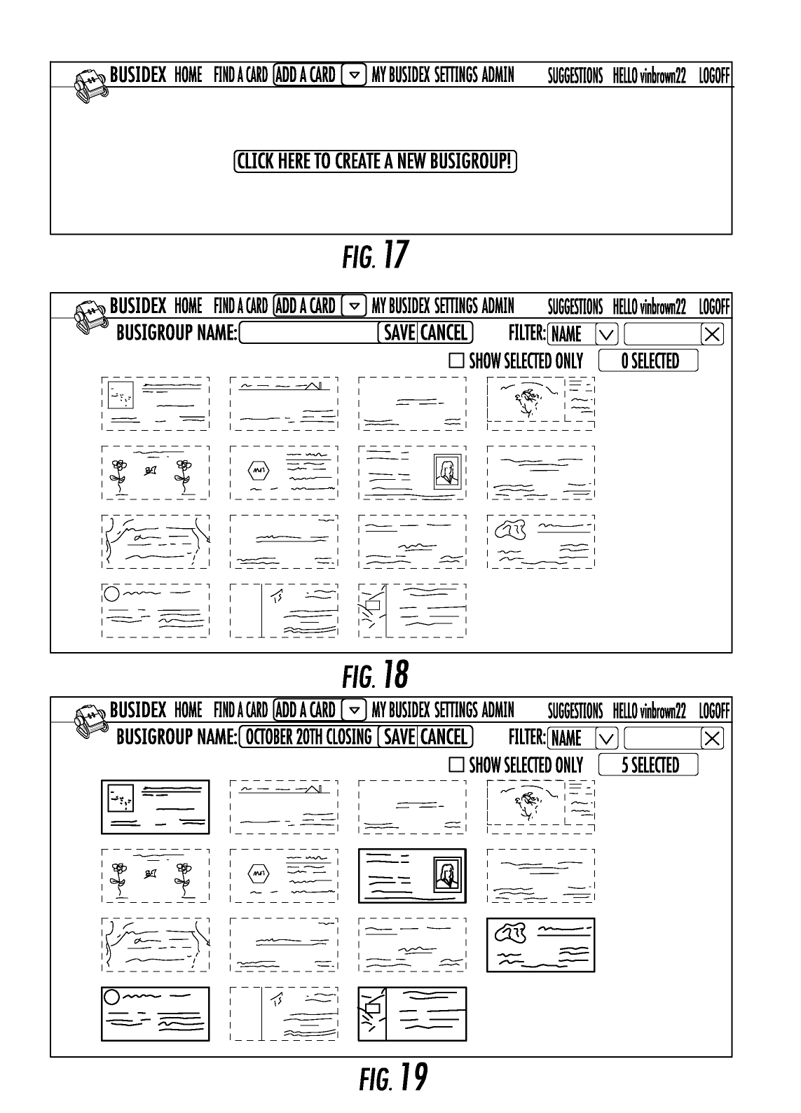

Referring to FIGS. 17 and 18, a user first creates the group by selecting an option to create a group and then assigning the group a name. The user then adds cards to the group via a graphical user interface, as shown in FIG. 19.

Referring to FIG. 20, the user then may view the group that they just created. The user may then share the group with other users by sending an invitation as described above with individual cards.

A user can organize Cards into specialized groups called Organizations. A user whose card is part of an Organization is said to have a Membership in that Organization. Therefore, these are presented to the user as Memberships. Users can belong to zero or many Organizations. Users can remove themselves from an Organization at any time. Users can Share a Card with the Administrator. All users who's card is contained in an Organization can view all the cards in the Organization. Cards within an Organization can be put into Groups. Users can only view the Groups to which they belong within an Organization. Members receive a notification when new cards have been added to the Organization. Notes are visible to everyone in the Organization. The Organization has a dedicated Home page which contains metadata about the Organization, including, Name, Logo, Url, Email, Contact Number, Social Media contact info (Twitter, Facebook, etc.) and Notes/Messages for members.

Users who do not own a Card can be added to an Organization as Guests.

Only the creator (Administrator) of the Organization can add or remove cards. Only the Administrator can add notes to the cards in the Organization. Only the Administrator can create/edit or delete Groups within the Organization. The Administrator of an Organization has a MyBusidex collection which is visible to all Members of the Organization, unlike the usual MyBusidex collection which is private to the user. This specialized collection is called the Organization Referral List. Only the Organization Administrator can accept or remove Cards in the Referral list. Only the Organization Administrator can update the information on the Home page.

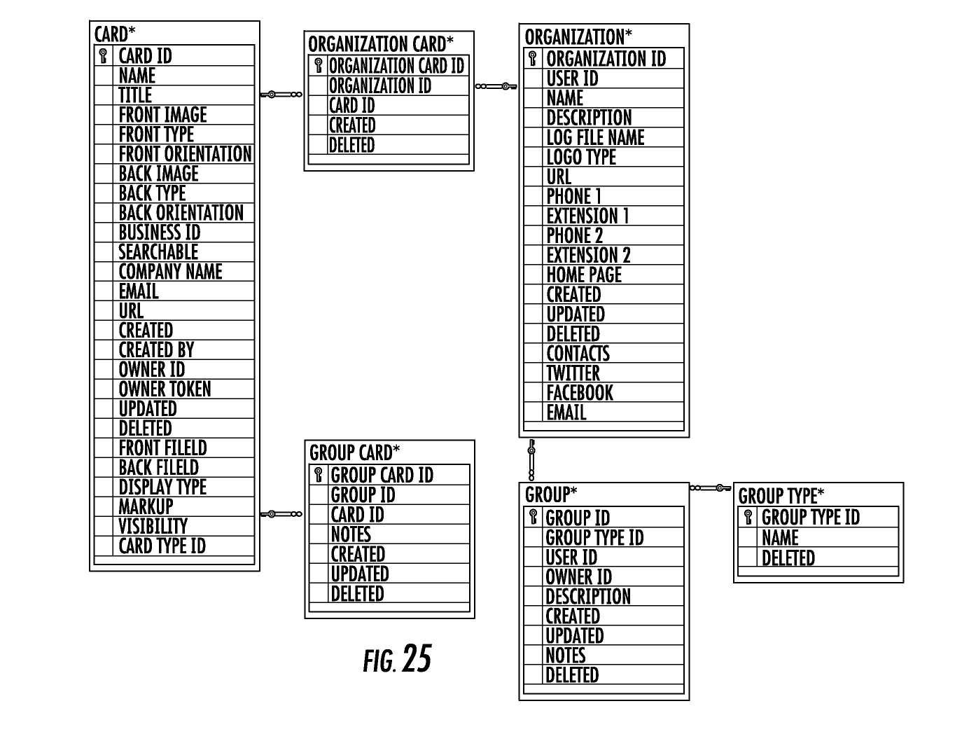

Referring, to FIG. 23, Memberships are presented to a User (non-administrator) as a menu bar option, where the User may view organizations that they are a member of.

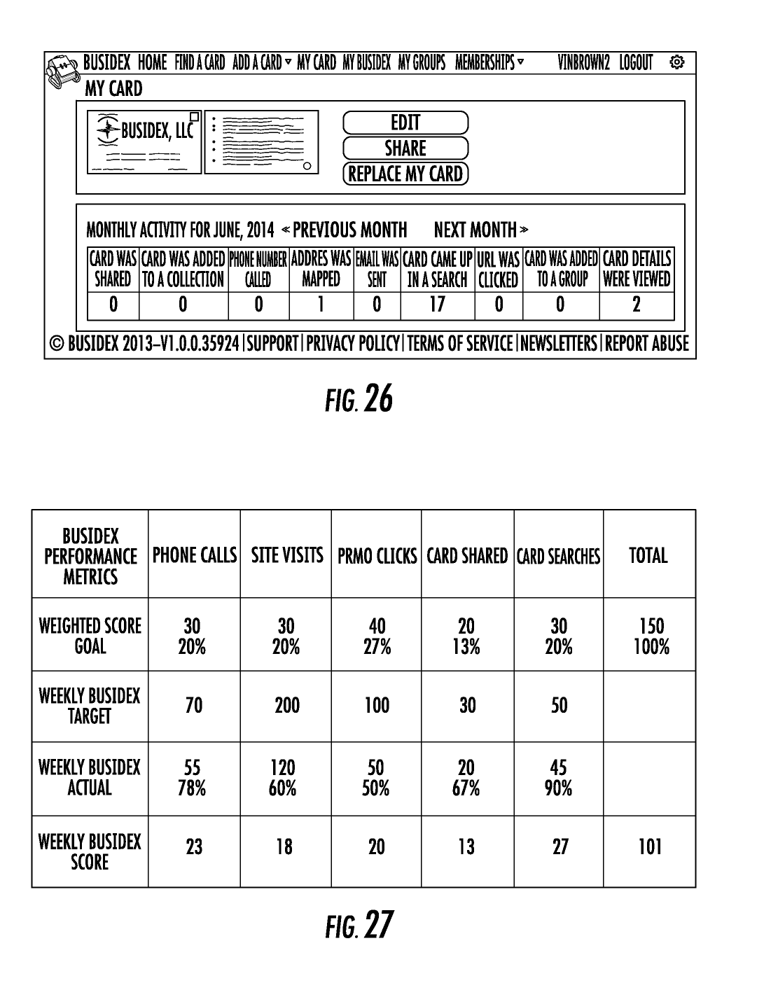

Referring to FIGS. 24 and 25, each membership has a type. These types are categorized in a Group Types table, which identifies three types of Groups a User may be a member. Specifically, these Group Types may be personal, Organization and Corporation. Personal groups are User defined groups that have no official organization. Organizations are more formal and may be used for non-profits, professional associations and other collective entities run by their members. The Corporation group types are for business entities. Whatever group type the Organization is, an organization has a relational structure that intersects with groups and cards. As noted earlier an Organization may have an Organization Card. A card may belong to many organizations or Groups. Individual Cards may also belong to many Groups or Organizations.

Enterprises are identical to Organizations in every way, with the distinction that where each Card within an Organization is owned individually by each Card Owner, Cards within an Enterprise are owned by one person/entity and managed by an Enterprise manager.

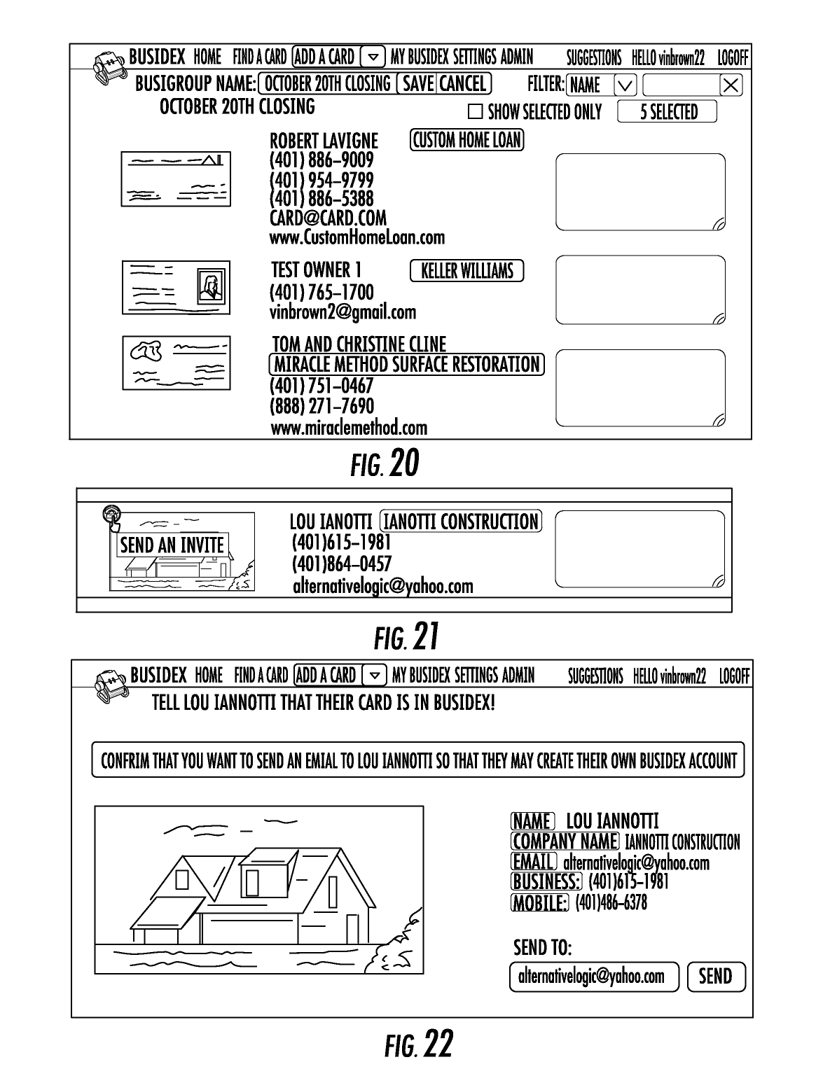

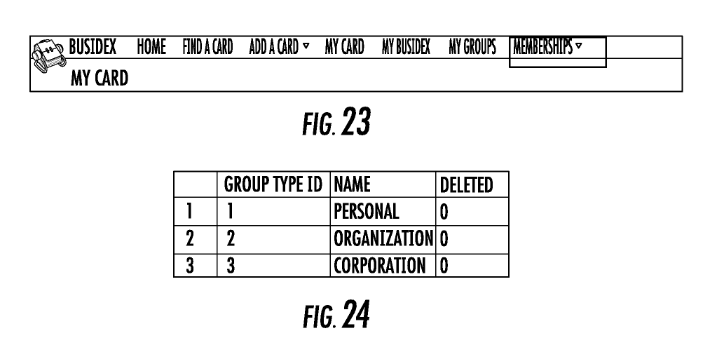

Referring back to FIGS. 21 and 22, a user may share a card with another person that does not have an account with Busidex Data Services. Users can invite business owners that do not have an account by adding a card of the business owner to the Busidex collection and then sending an invitation via email to the email address supplied for that card.

A business starts with a pool of points, much in the same way as when building a video game character. Just like the character, a business has attributes to which the user can assign points from the base pool. But you only have that pool to draw from. The user cannot assign all the points to all the attributes since they have a limited amount of resources and it would be impossible to put 100% of those resources on every aspect of the business.

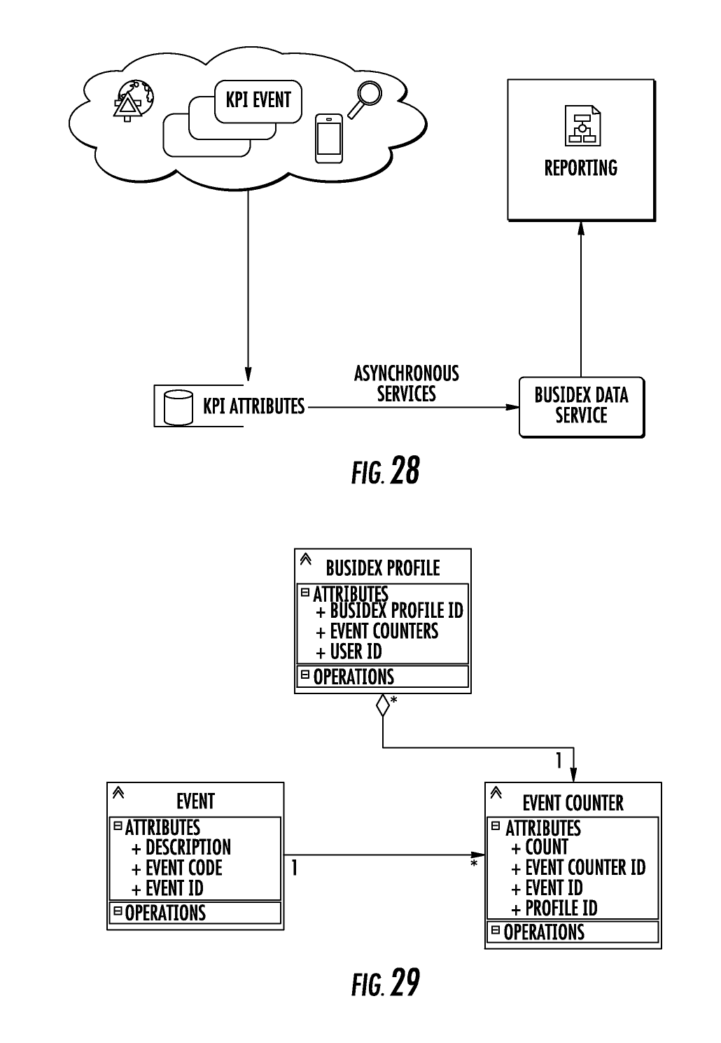

Referring to FIGS. 26 and 27, the first step is to define what attributes are most important to growing your business. The things in this list should not be what actually makes you money, but rather the things that *lead* to making you money. So it is not important to count how many orders were received in a given period, but rather what things were actively done that led to those orders. That might be number of phone calls, number of visits to your website, number of appointments set up and things of that nature. In the fictitious example illustrated in FIGS. 26 and 27, we see that Al's Pizza House has filled in the value points in the various metric categories (Busidex Performance Metrics) which it thinks/believes will drive revenue. According to this chart, Al's Pizza House believes that the most important area that needs to be focused on is promotions and getting people to use Busidex to access them.

Once this profile is set up, the Busidex data service tracks user actions in an anonymous fashion using aggregated KPI (Key Performance Indicator) counters that cannot be tied back to an individual. The following data points are used in the calculation of a Busidex Score:
a. Total Point Pool: An arbitrary number significantly large to allow for meaningful representation of individual performance metrics.
b. Weighted Score Goal (WSG): This is the value score (G) of a KPI as determined by the card owner in relation to a fixed base pool of points.
c. Weekly Busidex Target (WBT): This is the target number of times as determined by the card owner that a KPI event (T) occurs in the Busidex system.
d. Weekly Busidex Actual (WBA): The actual number of times a KPI event (A) occurs in the Busidex system.
e. Weekly Busidex Score (WBS): The weighted percentage score (S) of an individual KPI in relation to the total point pool, defined as S=Σ(G*(A/T)).

Referring to FIGS. 28 and 29, uysing events (interactions) within the Busidex platform, the system keeps counters and aggregates of system-defined and user-defined events. The flow of data within the system generally starts with an event. If the event meets certain attributes is it tracked and logged in the Busidex platform, which subsequently reports the results of these events to the user. An event has a data structure that defines the events qualities, and an event counter. The event counter is associated with each user that attends the event.

Each card owner has at least one Busidex Profile associated with them. A Busidex Profile consists of a collection of Event Counters. Events in the Busidex platform are predefined user interactions which represent a user making an active choice to engage in discourse (financial or informational) with the card owner. User-defined events may also be created, but are given a less weighted value since there is no way to validate them within the system

Busidex Performance Metrics are significant because they represent validated data within the system. In contrast to non-validated event data—for example, star ratings and reviews—validated metrics have intrinsic positive value to the card owner because they show proof of a user action with the intent to do business or inquire about doing business with the card owner, and represent an action with the opportunity for reaction by the card owner.

By using the card data (phone numbers, email, website url, etc.) the Busidex Data Service can gather these events and generate Busidex Performance Metrics in near-real-time.

Therefore, it can be seen the method and system described herein provides a unique approach to sharing and propagating contact information among users that is easy to update and maintain.

It would be appreciated by those skilled in the art that various changes and modifications can be made to the illustrated embodiments without departing from the spirit of the present invention. All such modifications and changes are intended to be within the scope of the present invention except insofar as limited by the appended claims.

What is claimed is:

1. A method of tracking performance metrics of contact data in a networked computer environment, the contact data comprising organizations, events, event counters, and cards, the method comprising:
assigning points from a point pool to a plurality of events according to user desired importance of each event over a specified time frame;
tracking event occurrences (A) within the specified time frame; and
reporting the result of the event occurrences (A) versus event targets.

2. The method of claim 1, further comprising calculating a weighted score goal (G) based on the assigned points of an event related to the point pool.

3. The method of claim 2, wherein the weight score goal (G) is a percentage of assigned points in relation to the point pool.

4. The method of claim 2, further comprising assigning a desired a weekly event target (T) to each event.

5. The method of claim 4, wherein the event target is the desired number of weekly event occurrences.

6. The method of claim 4, further comprising calculating a weighted percentage score (S) of a weekly event target (T) in relation to the total point pool.

7. The method of claim 6, wherein calculating the weighted percentage score (S) is defined as the sum of weighted score goal multiplied by the event occurrences divided by the weekly event target for each event.

8. The method of claim 1, wherein the plurality of events includes phone calls, site visits, promo clicks, card shared, and card searched.

9. A method of tracking performance metrics of contact data in a networked computer environment, the contact data comprising organizations, events, event counters, and cards, the method comprising:
assigning points from a point pool to a plurality of events according to user desired importance of each event over a specified time frame;
calculating a weighted score goal (G) based on the assigned points of an event related to the point pool;
assigning a desired weekly event target (T) to each event, representing the desired number of weekly event occurrences;
tracking event occurrences (A) within the specified time frame;
calculating a weighted percentage score (S) of a weekly event target (T) in relation to the total point pool; and
reporting the result of the event occurrences (A) versus event targets.

10. The method of claim 8, wherein the weight score goal (G) is a percentage of assigned points in relation to the point pool.

11. The method of claim 8, wherein calculating the weighted percentage score (S) is defined as the sum of weighted score goal multiplied by the event occurrences divided by the weekly event target for each event.

12. The method of claim 8, wherein the plurality of events includes phone calls, site visits, promo clicks, card shared, and card searched.

13. A method of managing contact data on a networked computer environment, the networked computer environment including a data storage, a processor, and a program memory, the method comprising:
providing a user interface configured to display and input a plurality of cards having contact information, the user interface having user interface logic operative to cause the processor and memory to display a user interface for a user;
creating a database configured to store and retrieve cards on the data storage; the database having logic operative to cause the processor and memory to create, read, update and delete contact information in the data storage;
defining each card to include a Card Owner field, designating the owner of the card;
defining each card to include one or more relationships with other cards in the database;
creating a plurality of user accounts, each user account including a collection of cards;
creating a plurality of groups with which each user account may selectively associate.

14. The method of claim 13, wherein each groups has a group type

15. The method of claim 14, wherein the group types are organizations, personal, and corporation.

16. The method of claim 13, further comprising assigning an administrator to the group.

17. The method of claim 13, further comprising creating a group card for each group, wherein each group card has a collection of user cards associated therewith.

18. The method of claim 13, further comprising creating a plurality of enterprises having a plurality of cards associated therewith wherein the Card Owner field is set to indicate the enterprise.

19. The method of claim 18, further comprising assigning an enterprise manager to the enterprise.
